(19) United States
(12) Patent Application Publication
(10) Pub. No.: US 2026/0203051 A1
(43) Pub. Date: Jul. 16, 2026

(54) RESTRUCTURING AN ORGANIZATION ACCORDING TO SOFTWARE ARCHITECTURE

(71) Applicant: Dell Products, L.P., Round Rock, TX (US)

(72) Inventors: Igor Dubrovsky, Beer Sheva (IL); Boris Shpilyuck, Ashdod (IL); Nisan Haimov, Beer Sheva (IL)

(21) Appl. No.: 19/020,076

(22) Filed: Jan. 14, 2025

(51) Int. Cl. G06F 8/71; G06F 8/36

(52) U.S. Cl. CPC G06F 8/71; G06F 8/36

(57) ABSTRACT

Recommendations for realigning an organization structure to be more consistent with software development project architectures are provided or facilitate. For example, a directed organization graph (OG) can be generated from human resource data or other data. A service mesh (SM) graph can be generated from version control system data or other data. Based on the OG, the SM graph, and a defined distance threshold, misalignments can be identified and various restructuring options can be generated that recommend realignments for the organization structure that better match the software development project architectures.

### BACKGROUND

In a general sense, provision of something “as a service” indicates terms of art used in the technology industry to describe a service delivery model where a provider delivers a particular service over the internet on a subscription basis. Such focuses on a model in which the service is provided remotely via the internet, eliminating the need for customers to install or maintain on-premises hardware or software. Organizations often adopt microservices architectures to improve scalability, modularity, and speed of development. In a microservices environment, an application is decomposed into a collection of loosely coupled services that communicate over defined interfaces or APIs. This design approach increases flexibility, allowing each service to be developed, deployed, and maintained independently, especially in a software as a service (SaaS) environment, where high availability can be more critical.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts a schematic block diagram illustrating certain functionality or operation of an orchestration platform in accordance with certain embodiments of this disclosure;

FIG. 2 depicts a schematic block diagram is depicted illustrating realignment device that can provide organization restructuring recommendations based on microservices architecture in accordance with certain embodiments of this disclosure;

FIG. 3 illustrates an example directed graph representing an illustrative example of the OG in the context of a developer organization, Techflow, Inc., in accordance with certain embodiments of this disclosure;

FIG. 4 illustrates an example directed graph representing an illustrative example of SM graph in the context of the software development project that is managed by the developer organization in accordance with certain embodiments of this disclosure;

FIG. 5A depicts a schematic block diagram illustrating various example sources of data that can be used in constructing the organization graph in accordance with certain embodiments of this disclosure;

FIG. 5B depicts a schematic block diagram illustrating various example sources of data that can be used in constructing the service mesh graph in accordance with certain embodiments of this disclosure;

FIG. 6 depicts a schematic block diagram graphically illustrating an example of the organization distance and/or shortest path between worker 4 and worker 10 in accordance with certain embodiments of this disclosure;

FIG. 7 depicts an example schematic block diagram illustrating various restructuring options being provided to alleviate misalignments in accordance with certain embodiments of this disclosure;

FIG. 8 depicts a schematic block diagram is depicted illustrating an example device that can generate recommendation data to resolve misalignments between organization structure and microservices architecture in accordance with certain embodiments of this disclosure;

FIG. 9 illustrates an example method that can generate recommendation data to resolve misalignments between organization structure and microservices architecture in accordance with certain embodiments of this disclosure;

FIG. 10 illustrates an example method that can provide for additional functionality or elements relating to generating recommendation data to resolve misalignments between organization structure and microservices architecture in accordance with certain embodiments of this disclosure;

FIG. 11 illustrates a block diagram of an example distributed file storage system that employs tiered cloud storage in accordance with certain embodiments of this disclosure; and

FIG. 12 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

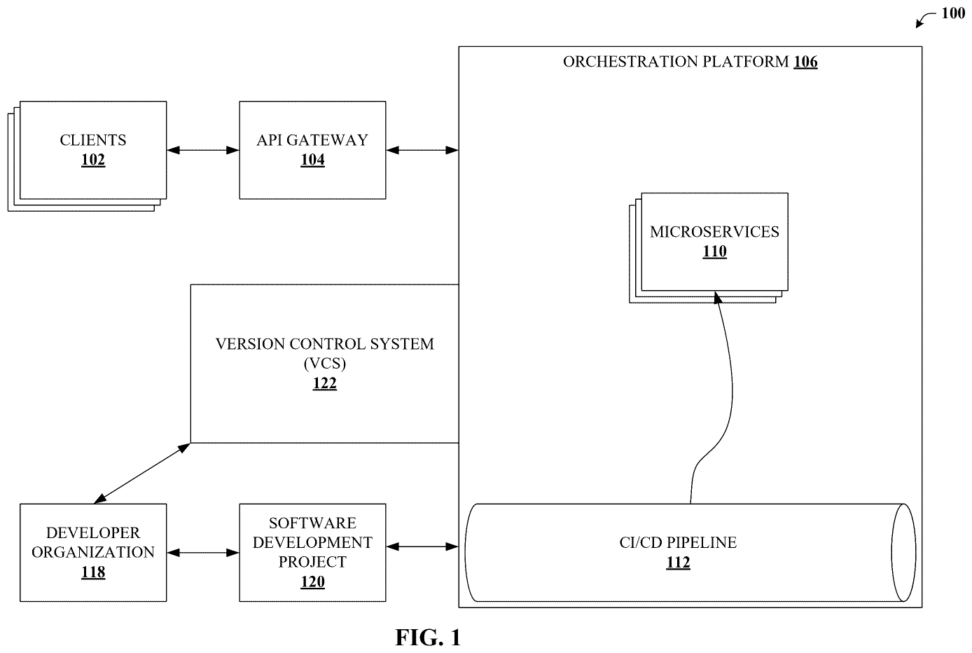

To provide additional context for the disclosed subject matter, consider an example architecture associated with an orchestration platform, illustrated in connection with FIG. 1. FIG. 1 depicts a schematic block diagram 100 illustrating certain functionality or operation of an orchestration platform 106 in accordance with certain embodiments of this disclosure. As used herein, orchestration platform 106 can be any suitable software development and/or software deployment platform such as a microservices platform. In some embodiments, orchestration platform 106 can be a containerized orchestration platform such as Kubernetes, Docker Swarm, or the like. In general, orchestration platform 106 can facilitate the management, provisioning, and configuration of multiple environments 110 in order to support software development, testing, and deployment workflows.

Thus, as a representative example, orchestration platform 106 relates to the deployment of microservices 110, but it is understood that any type of software element, other than microservices 110 specifically, can be suitable. Microservices 110 can communicate with one another via well-defined application programming interfaces (APIs), such as representational state transfer (REST) APIs, also referred to as RESTful APIs. Each microservice 110 can represent a loosely coupled, independently deployable, self-contained service that serves a specific function or capability. Microservices 110 can differ from traditional monolithic applications due to this architectural design. For example, an application can make API calls to one or more microservices 110 instead of coding the function or capability into the application in a monolithic way. Hence, a given microservice 110 can provide a dedicated function or capability to many different applications or other microservices 110 in a more resilient and scalable manner.

For example, clients 102 that execute applications can make calls to microservices 110 of orchestration platform 106. Optionally, any such communication can be via API gateway 104. API gateway 104 can be a server that acts as a single entry point for clients 102 to access multiple microservices 110. API gateway 104 can serve as a reverse proxy that routes requests from clients 102 to the appropriate microservices 110, abstracting away potential complexities of the underlying microservices architecture.

It is appreciated that in the context of this disclosure, orchestration platform 106 can be any suitable platform that provides access to microservices 110. Such can be any suitable cloud-based services platform, a containerized workflow platform or container orchestration platform such as Kubernetes or another system or platform.

To these and other ends, developer organization 118 can comprise developers or teams of developers who contribute to some software development project 120 such as the development of one or more microservices 110 or other software elements. Hence, orchestration platform 106 can comprise or be communicatively coupled to version control system (VCS) 122. For example, any environment of orchestration platform 106 can integrate with VCS 122 in order to potentially automate a build, test, or deployment process.

Furthermore, in some embodiments, orchestration platform 106 can be integrated with continuous integration/continuous deployment (CI/CD) pipeline 112. CI/CD pipeline 112 can represent any suitable development operations (DevOps) pipeline. CI/CD pipeline 112 can integrate seamlessly with orchestration platform 106 to automate the deployment and management of applications or other software components such as microservices.

In more detail, VCS 122 can relate to a system or device that can help developer organization 118 manage changes to source code and other files over time such as software development project 120. VCS 122 can provide a centralized repository where developer organization 118 can store, track, and collaborate on code changes, enabling teams to work together efficiently and maintain a history of revisions. VCS 122 can facilitate history tracking (e.g., VCS 122 can record all changes made to files in the repository), branching and merging (e.g., VCS 122 can support branching to create separate lines of development without affecting the main codebase), collaboration (e.g., VCS 122 can enable multiple developers to work on the same codebase concurrently), backup and recovery (e.g., VCS 122 can serve as a centralized backup mechanism for code and project asses of software development project 120), auditing and compliance (e.g., VCS 122 can proved a complete audit trail of code changes, allowing monitoring of access, permissions, contributions, and so on), and experimentation and versioning (e.g., VCS 122 can enable developer entity 118 to experiment with new ideas, features, or configurations via branching or tags for different versions of code).

As previously noted, organizations often adopt microservices architectures to improve scalability, modularity, and speed of development. Despite the advantages associated with microservices, many organizations struggle to realize the full potential of microservices when their internal team structures remain misaligned with the underlying service architecture. Traditional organizational hierarchies often separate key contributors, introduce communication bottlenecks, and hinder collaborative problem-solving between teams responsible for interdependent services. As a result, development cycles can slow, system reliability may suffer, and overall productivity can decline. Addressing this organizational misalignment has therefore become a significant challenge for enterprises seeking to optimize their microservices deployments.

Put differently, many enterprises retain traditional organizational structures that do not reflect the natural boundaries or interdependencies within a microservices architecture. Such misalignment can lead to communication gaps, conflicting objectives, and prolonged development cycles. Teams responsible for interdependent microservices 110 may be separated by multiple managerial layers or operate under different reporting lines, causing inefficiencies in collaboration and slower resolution of production issues. Existing approaches to organizational design have not comprehensively addressed these challenges, creating a need for a systematic method to align organizational structures with microservices architectures.

In other words, a common challenge in organizations adopting microservices is ensuring that the organizational structure aligns with the microservices architecture. Misalignments can occur when the teams responsible for interdependent services are separated by significant organizational distances, leading to communication gaps, conflicting goals, and reduced productivity. These issues can be exacerbated in large organizations where different teams might be geographically dispersed or report to different managers

The disclosed subject matter, in some embodiments, is directed to resolving the above-mentioned issues. For example, the disclosed embodiments can systematically align organizational structures with microservices architecture. Such can be accomplished by calculating the organizational distance between teams and identifying misalignments through graph analysis. This approach can provide actionable insights for restructuring the organization, which can go beyond traditional organizational design by integrating service mesh analysis with organizational graphs, ensuring that teams working on interdependent microservices are closely aligned.

### Example Systems

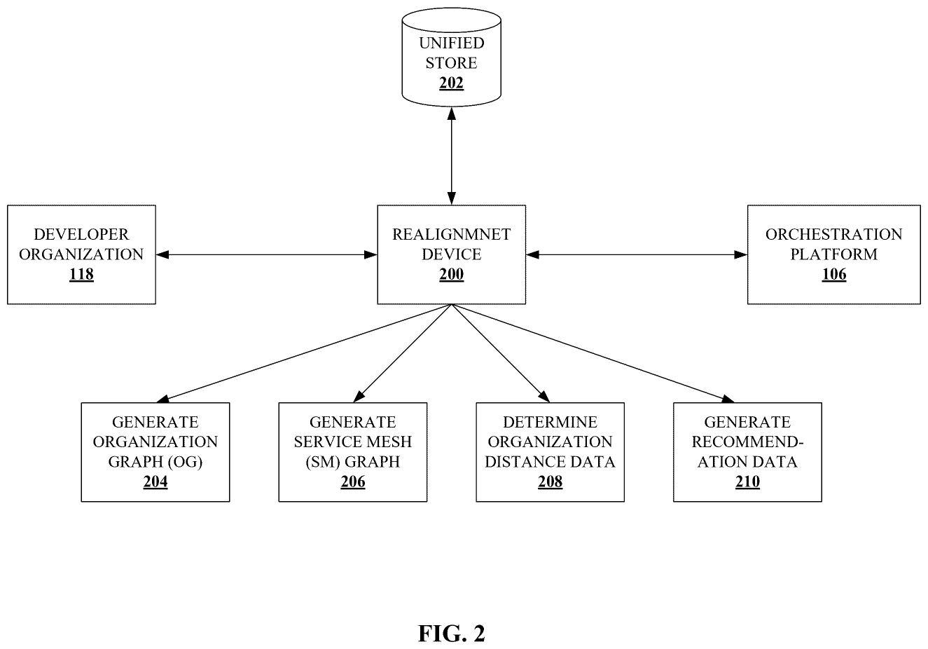

With reference now to FIG. 2, a schematic block diagram is depicted illustrating realignment device 200 that can provide organization restructuring recommendations based on microservices 110 architecture in accordance with certain embodiments of this disclosure. In some embodiments, realignment device 200 can generate organization graph (OG) 204 and service mesh graph 206.

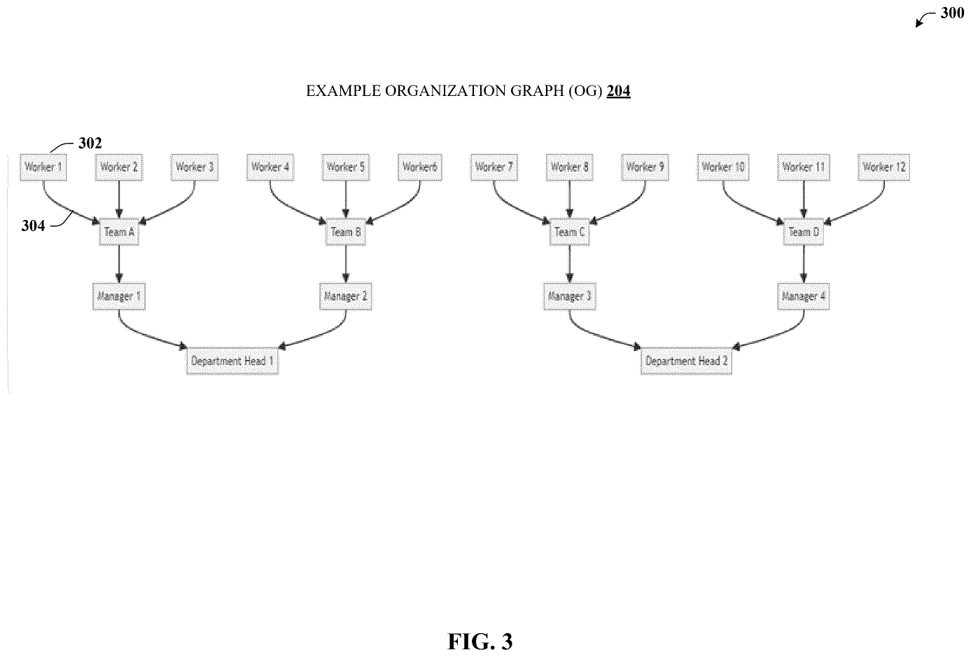

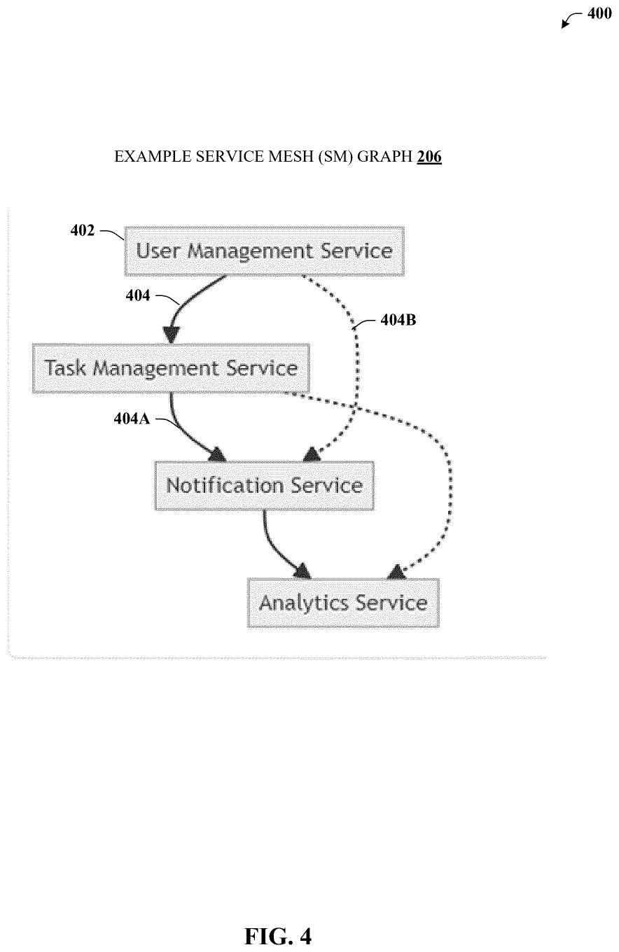

Examples of OG 204 and SM graph 206 can be respectively found at FIGS. 3 and 4 in the context of a hypothetical company, TechFlow, Inc., commonly referred to herein as Techflow. It is appreciated that TechFlow can thus represent a developer organization 118 and the associated microservices 110 developed by TechFlow can represent software development project 120.

FIG. 3 illustrates an example directed graph 300 representing an illustrative example of OG 204 in the context of a developer organization 118, Techflow, Inc., in accordance with certain embodiments of this disclosure. FIG. 4 illustrates an example directed graph 400 representing an illustrative example of SM graph 206 in the context of software development project 120 being developed by the developer entity 118.

In this example, OG 204 is a directed graph representing a hierarchy of an organization, in this case TechFlow. OG nodes 302 can represent organization entities that contribute in some way to the software development project 120. These organization entities can be indicative of a role performed and can be an individual (e.g., worker or developer) or a team. OG edges 304 can be indicative of hierarchical reporting lines of TechFlow's organization entities. For instance, in this example, worker 1, worker 2, and worker 3, represent team A, all of which report to manager 1.

As illustrated with respect to FIG. 4, SM graph 206 can represent interactions between software elements (e.g., microservices 110) of the software development project 120 and can comprise SM nodes 402 and SM edges 404. SM nodes 402 can be indicative of software elements such as individual microservices 110. SM edges 404 can be indicative of certain relationships between associated SM nodes 402. The relationship can be, e.g., a dependency, an application programming interface (API) call, a data flow among the associated SM nodes, and so on.

Hence, in some embodiments, the relationship represented by SM edges 404 can be a direct relationship 404A (illustrated by a solid line) or an indirect relationship 404B (illustrated by a dashed line). Whether a relationship is characterized as a direct or indirect one can be a function of, e.g., a type of dependency (e.g., synchronous API call vs. asynchronous messaging), a criticality of a given relationship between two microservices 110, a priority level of the given relationship between two microservices 110, a service-level agreement associated with the given relationship, and so forth. Moreover, whether a given relationship is characterized as a direct or indirect one can affect certain distance thresholds (e.g., allowable distance between two nodes) as will be further explained below.

As can be seen from OG 204 and SM graph 206, TechFlow includes a total of 12 workers (e.g., developers) contributing to a particular software development project 120. These 12 workers are evenly divided between four teams, each of which report to one of four different managers. The four managers report to one of two different department heads.

Regarding SM graph 206, development project 120 comprise four different microservices, namely, a user management service (UMS), a task management service (TMS), a notification service (NS) and an analytics service (AS). As shown, the UMS has a direct relationship with the TMS and an indirect relationship with NS. As indicated, direct relationships are indicated by SM edge 404A while indirect relationships are indicated by SM edge 404B. TMS has a direct relationship with NS and an indirect relationship with AS. NS has a direct relationship with AS.

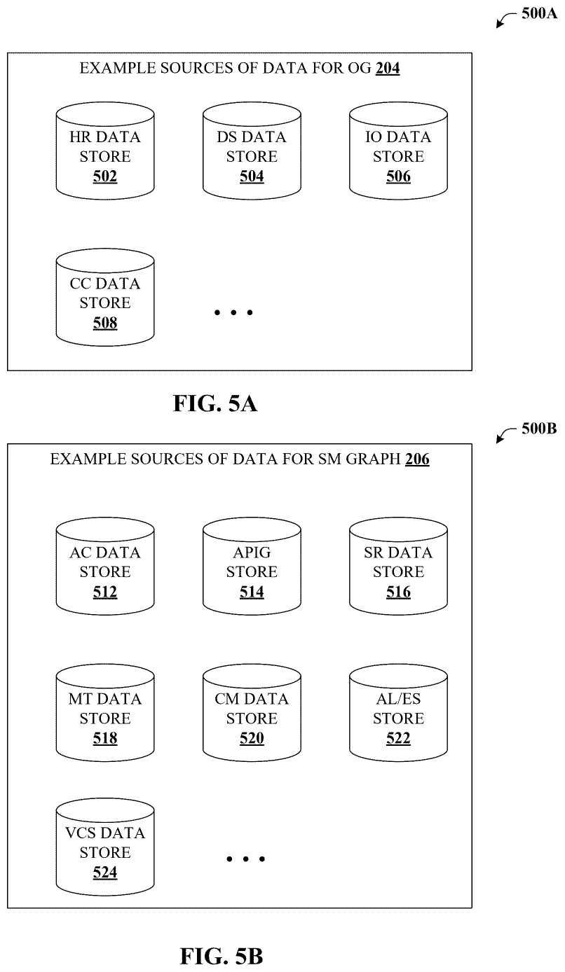

Referring back to FIG. 2, as illustrated realignment device 200 can communicate with developer organization 118 (e.g., TechFlow) and orchestration platform 106. Such communication can be used to collect the information that is leveraged for constructing OG 204, SM graph 206, and other elements detailed herein. In some embodiments, the various data can be collected and placed in unified store 202 should such be desired. Example of potential sources of data used can be found with reference to FIGS. 5A and 5B.

FIG. 5A depicts a schematic block diagram 500A illustrating various example sources of data that can be used in constructing the OG 204 in accordance with certain embodiments of this disclosure. One example source can be a human resource (HR) store 502. Company or organization HR systems (e.g., Workday, SAP SuccessFactors, . . . ) often maintain up-to-date records of employee details, organizational hierarchies, job titles, and reporting lines. Another example source can be a directory services (DS) data store 504. For example, directory services (e.g., Microsoft Active Directory, LDAP, Okta, . . . ) can store user account information, group memberships, and organizational relationships that can be extracted to construct hierarchy nodes and edges.

Another example source can be internal organization (IO) data store, which can relate to manually curated or automatically generated org charts (e.g., often in corporate wikis, intranets, or project management tools) that provide visual representations of teams and reporting structures. Still another example source can be collaboration and communication (CC) data store 508, which can relate to platforms such as Slack, Microsoft Teams, or email services that can supply historical interaction data. While potentially not hierarchical in nature, this information can supplement OG 204 in ways that are further detailed herein such as providing evidence of real-world collaboration paths and/or those who actively communicate or work together. Other sources of information for OG 204 can of course exist.

FIG. 5B depicts a schematic block diagram 500B illustrating various example sources of data that can be used in constructing the SM graph 206 in accordance with certain embodiments of this disclosure. For example, certain data used to construct SM graph 206 can be obtained from an application configuration store 512. Such can include application configuration files or infrastructure-as-code files. Files such as Kubernetes manifests, Docker compose files, Terraform configurations and so forth often list microservice names, ports, and dependencies such as which services call which APIs or the like.

Another example source can be API gateway (APIG) store 514. Such can store API gateway logs (e.g., Kong, NGINX, Istio, . . . ) or reverse proxies that can provide real-time data on which microservices communicate with one another, potentially providing detailed information on direction, frequency, and types of calls made. Another example source can be service registries (SR) data store 516. For instance, tools such as Consul, Eureka, Zookeeper, and so forth can maintain records of active services, their network addresses, and metadata (e.g., version, region, . . . ). These registries can be mined to understand which services are registered and how they interconnect.

Another example source of data that can be leveraged for SM graph 206 can be monitoring and tracing (MT) data store 518. MT data store 518 can relate to observability tools (e.g., Prometheus, Grafana, Jaeger) that can collect metrics and distributed tracing data that can show service call paths, latency, and dependencies in real time. Another potential source can be configuration management (CM) data store 520, sometimes referred to as CMDB. CMDBs in enterprise environments can store detailed dependency graphs between systems, including microservices and supporting infrastructure components.

Another example source of data that can be leveraged for SM graph 206 can be application logs and event stream (AL/ES) store 522. AL/ES store 522 can relate to log aggregators (e.g., Elastic Stack, Splunk, . . . ) or event streaming platforms such as Apache Kafka, which can reveal internal service-to-service communication patterns based on message flows or transaction traces. Still another potential source of suitable data can be collected from version control system (VCS) data store 524 and build pipelines. Such can be obtained from VCS 122 and/or CI/CD pipeline 112 detailed in connection with FIG. 1. In that regard, project reference, build artifacts, or CI/CD metadata (e.g., Jenkins, GitHub Actions, . . . ) can indicate how microservices are orchestrated, referencing the services each component depends on and triggers in its deployment process.

Still referring to FIG. 2, regardless of the many potential sources of information that can be relied upon, once that information is obtained, such can be copied or temporarily stored in unified store 202 or otherwise used to generate OG 204 and SM graph 206. In some embodiments, unified store 202 can also store OG 204 and SM graph 206. Hence, a different device might generate graphs 204 and 206, which can be subsequently input to realignment device 200 in order to better align organization structure with microservices architecture.

In this example, and referencing FIGS. 3 and 4, suppose TechFlow has decided in a straightforward manner to assign team A to UMS, team B to TMS, team C to NS, and team D to AS. Hence, manager 1 and manager 2 both report to department head 1, while manager 3 and manager 4 both report to department head 2.

From SM graph 206, it can be assumed that UMS interacts with TMS, e.g., to assign tasks to users. TMS uses the NS, e.g., to notify the users of task updates. AS aggregates data from TMS and NS to, e.g., generate performance analytics. Realignment device 200 can determine organization distance 208 between one or more relevant pairs of OG nodes 302. Organization distance 208 can represent a distance between two workers (or teams) and can be calculated as the length of the shortest undirected path between two associated OG nodes 302 in OG 204. More formally, this can be expressed as:

$$Org\_Distance ( {w}_{i} , {w}_{j} ) min ( Path\_Length ( {w}_{i} , {w}_{j} ) )$$

Where wᵢ, wⱼ can be the OG nodes 302 being compared and Path_Legth(wᵢ, wⱼ) can represent the lengths of all possible paths between wᵢ and wⱼ. In this example, it is known that worker 4 (e.g., team B) has been assigned to TMS, whereas worker 10 (e.g., team D) has been assigned to AS.

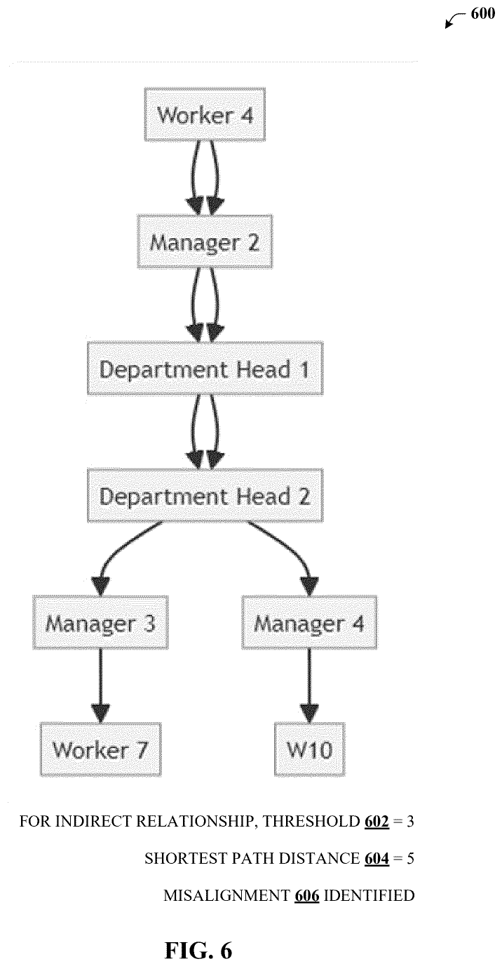

FIG. 6 depicts a schematic block diagram 600 graphically illustrating an example of organization distance 208 and/or shortest path distance 604 between worker 4 and worker 10 in accordance with certain embodiments of this disclosure. Since the shortest path distance 604 between worker 4 and worker 10 is 5, then organization distance 208 can be 5 as well. That is:

$$Org\_Distance ( {w}_{4} , {w}_{10} ) = 5$$

Based on this organization distance 208, misalignment device 200 can then check for a misalignment 606. A misalignment 606 can exist when the organization distance 208 is greater than some defined threshold 602. Such comes into play when two OG nodes 204 represent members who contribute to interdependent microservices as indicated by SM graph 206. If the organization distance 208 between those two OG nodes 204 (e.g., working on interdependent microservices) is greater than threshold 602, then a misalignment 606 can be identified. Thus, misalignment 606 can indicate that the structure of the organization is not properly aligned with the microservices architecture. Hence:

$$Misalignment = \{ \begin{matrix}1 & if Org\_Distance ( {w}_{i} , {w}_{j} ) > T \\ 0 & if Org\_Distance ( {w}_{i} , {w}_{j} ) \leq T\end{matrix}$$

Where T is equal to threshold 602. It is significant to note that threshold 602 can be configurable by the organization. Further, threshold 602 can vary as a function of a type of relationship between two microservices 110. In this example, a direct relationship (e.g., SM edge 404A) existing in SM graph 206 can cause threshold 602 to be set to 2, whereas an indirect relationship (e.g., SM edges 404B) can cause threshold 602 to be extended to 3, for example.

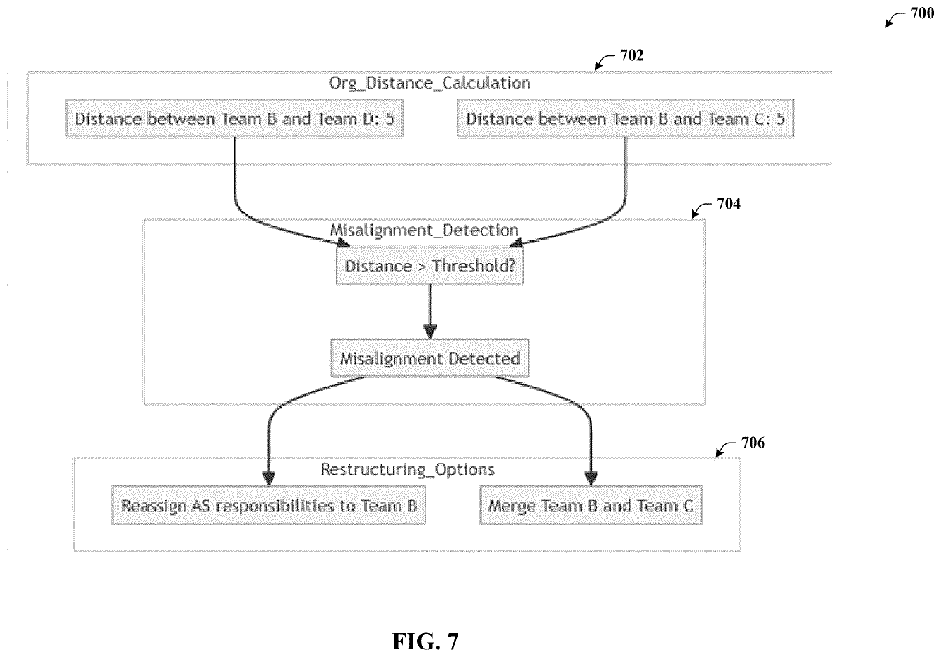

Thus, with the stated organizational structure vis-à-vis the microservices architecture, it can be observed that many misalignments 606 can be identified. In response, realignment device 200 can generate recommendation data 210. Recommendation data 210 can be representative of a realignment recommendation that indicates a change to the hierarchy of the organization. The change to the hierarchy can be determined to mitigate or eliminate misalignments 606 in accordance with SM graph 206. Hence, one goal of the disclosed subject matter can be to reduce or minimize total misalignments 606, which is further detailed in connection with FIG. 7.

Turning now to FIG. 7, an example schematic block diagram 700 is depicted illustrating various restructuring options 706 being provided to alleviate misalignments 606 in accordance with certain embodiments of this disclosure. It is appreciated that various operations detailed in diagram 700 can be performed by misalignment device 200 or other devices detailed herein. For example, Org_Distance_Calculation 702 can be substantially similar to the determination of organization distance data 208 detailed in connection with realignment device 200.

Here, it can be seen that the distance between team B and team D is 5 and also the distance between team B and team C is also 5. Thus, as indicated at Misalignment_Detection 704, misalignments 606 have been detected based on the configurable thresholds 602.

In response, Restructuring_Options 706 can be generated and provided to management or certain targets or entities. Such can be substantially similar to generating recommendation data 210 as detailed in connection with FIG. 2.

As was noted, one goal of the disclosed subject matter can be to reduce or minimize total misalignments 606. This can be formalized as:

$$Minimize {\sum }_{( {w}_{i} , {w}_{j} )} Misalignment ( {w}_{i} , {w}_{j} )$$

Where the sum can be taken over all pairs (wᵢ, wⱼ) working on interdependent microservices 110.

As an optimization example, suppose we have identified the following misalignments: Misalignment(w₄, w₇)=1 and Misalignment(w₄, w₁₀)=1. In order to minimize these particular misalignment results, we consider different restructuring options. For example, as shown in Restructuring_Options 706, one option can be to reassign AS responsibilities to team B. This option can reduce organization distance 208 between worker 4 and worker 10, thereby removing one of the two misalignments. It is noted that the misalignment between worker 4 and worker 7 remains.

A second option can be to merge teams B and C. This option can resolve the misalignment between worker 4 and worker 7 by bringing the two services under a single management structure. However, otherwise, the misalignment between worker 4 and worker 10 would remain. However, by combining both options (e.g., implementing both options) total misalignments 606 can be reduced to zero in this example.

As can be observed, a benefit of the disclosed system can relate to the ability to streamline communication and collaboration. By measuring and minimizing the organizational distance between teams that work on interdependent microservices, the system reduces the number of hierarchical layers or managerial steps required for communication. This helps teams resolve issues more rapidly, share expertise efficiently, and deliver new features to market faster. Consequently, software quality can improve and critical production issues are resolved more quickly.

Another significant advantage can lie in the capacity to provide actionable insights for reorganizing team structures. Many organizations struggle to detect hidden organizational barriers—especially those that emerge as companies grow and add new layers of management. The disclosed approach, based on both service mesh analytics and organizational graph analysis, gives decision-makers a clearer view of where misalignments are occurring and what changes are most effective at mitigating them. Such can aid leadership in making informed decisions, either by merging teams, reassigning personnel, or restructuring management lines, with the confidence that such alterations will contribute positively to overall system performance.

In addition, the disclosed subject matter can facilitate continuous improvement over time. Organizational structures and microservices architectures alike are subject to frequent changes—new hires, project re-scopes, changing consumer demands, or the addition of new microservices. Because the system continuously captures organizational data and service mesh information, it can repeatedly apply the same metrics and optimization algorithms to flag emerging misalignments. This ongoing alignment can ensure that the benefits of microservices in terms of agility, scalability, and fault tolerance are preserved, allowing enterprises to remain adaptable and competitive in fast-evolving markets.

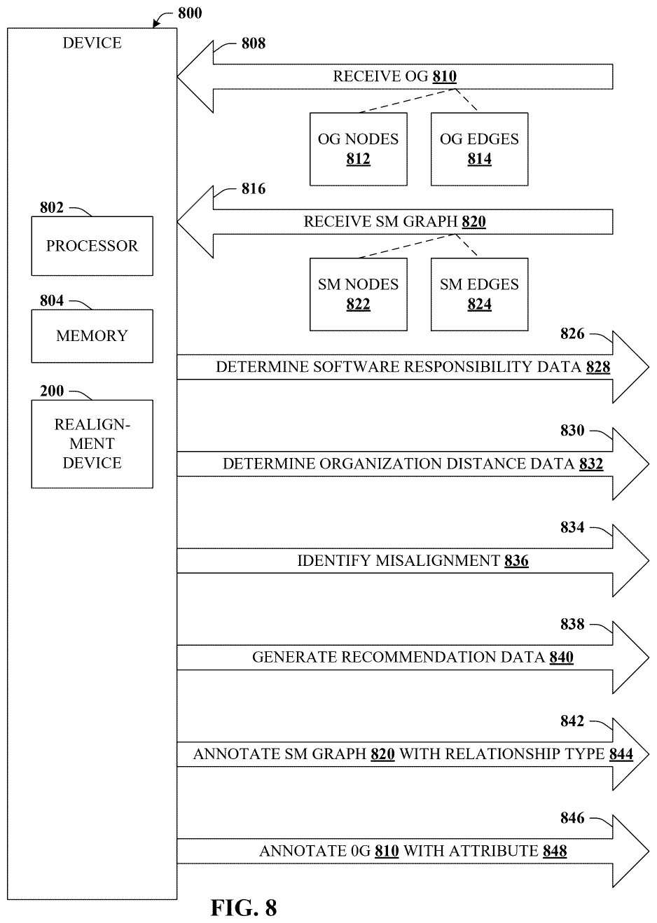

With reference now to FIG. 8, a schematic block diagram is depicted illustrating an example device 800 that can generate recommendation data 840 to resolve misalignments between organization structure and microservices architecture in accordance with certain embodiments of this disclosure. In some embodiments, device 800 can be integrated with, a portion of, or communicatively coupled to a microservices platform or an orchestration platform such as orchestration platform 106.

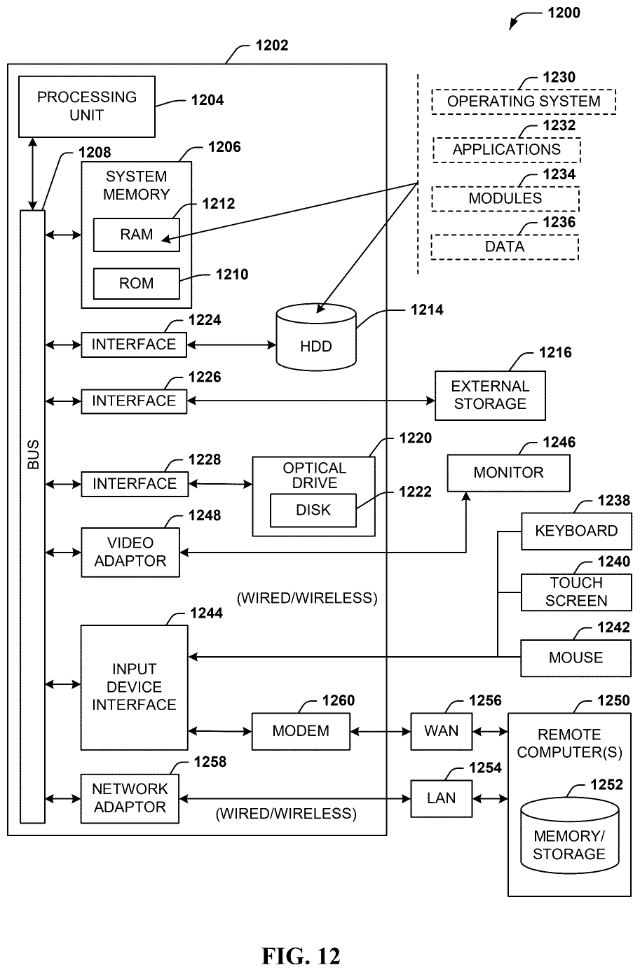

Device 800 can comprise a processor 802 that, potentially along with realignment device 806 (e.g., realignment device 200), can be specifically configured to perform functions associated with detection and remediation of misalignments between organization structure and software element (e.g., microservices 110) architecture. Device 800 can also comprise memory 804 that stores executable instructions that, when executed by processor 802, can facilitate performance of operations. Processor 802 can be a hardware processor having structural elements known to exist in connection with processing units or circuits, with various operations of processor 802 being represented by functional elements shown in the drawings herein that can require special-purpose instructions, for example, stored in memory 804 and/or realignment device 806. Along with these special-purpose instructions, processor 802 and/or realignment device 806 can be a special-purpose device. Further examples of the memory 804 and processor 802 can be found with reference to FIG. 12. It is to be appreciated that device 800 or computer 1202 can represent a server device or a client device of a network or data services platform and certain elements of computer 1202 can be used in connection with implementing one or more of the systems, devices, or components shown and described in connection with FIG. 8 and other figures disclosed herein.

As illustrated at reference numeral 808, device 800 can receive OG 810. OG 810 can be substantially similar to OG 204, an illustrative example of which can be found in connection with FIG. 3. OG 810 can represent a hierarchy of an organization (e.g., developer organization 118) that contributes to a software project (e.g., software development project 120). OG 810 can comprise OG nodes 812 (e.g., OG nodes 302) that can be indicative of organization entities (e.g., personnel, teams, . . . ) of the organization. OG 810 can further comprise OG edges 814 (e.g., OG edges 304) that can be indicative of hierarchical reporting lines of the organization.

At reference numeral 816, device 800 can receive SM graph 820. SM graph 820 can be substantially similar to SM graph 206, an illustrative example of which can be found in connection with FIG. 4. SM graph 820 can represent interactions between software elements (e.g., microservices 110) of the software project. SM graph 820 can comprise SM nodes 822 (e.g., SM nodes 402) that can be indicative of the software elements and SM edges 824 (e.g., SM edges 404) that can be indicative of relationships between associated SM nodes 822. In some embodiments, one or both OG 810 and SM graph 820 can be a directed graph.

At reference numeral 826, device 800 can determine software responsibility data 828. Software responsibility data 828 can indicate which of the organization entities are responsible for each one of the software elements of the software project. It is appreciated that such data (e.g., information relating to the contributions of various personnel to certain software elements can be determined from a VCS such as VCS 122 and/or VCS data store 524.

At reference numeral 830, device 800 can determine organization distance data 832 (e.g., organization distance 208). Organization distance data 832 can comprise one or multiple instances of a shortest path between two of the organization entities represented by OG nodes 812. The two organization entities can be determined based on software responsibility data (e.g., who works on what) to have contributed to two software elements that are interdependent as indicated by SM graph 820.

At reference numeral 834, device 800 can identify misalignment 836 (e.g., misalignment 606). Misalignment 836 can be identified in response to the shortest path being determined to be greater than a defined threshold. At reference numeral 838, device 800 can generate recommendation data 840. Recommendation data 840 can be representative of one or more realignment recommendations (e.g., Restructuring_Options 706) that indicate a change in the hierarchy of the organization. The change to the hierarchy can be determined to mitigate or eliminate the misalignment 836 in accordance with SM graph 820.

In addition, in some embodiments, as indicated at reference numeral 842, device 800 can annotate SM graph 820 with relationship type 844. In other words, the annotation can indicate relationship type 844 regarding a specific relationship between the associated SM nodes 822. For instance, relationship type 844 can be indicative of a direct relationship (e.g., indicated by SM edges 404A) or an indirect relationship (e.g., indicated by SM edges 404B. Relationship type 844 can be a function of at least one of a type of dependency, a criticality of a given relationship between two software elements, a priority level of the given relationship between two software elements, or a service-level agreement associated with the given relationship. Furthermore, in some embodiments, relationship type 844 can affect the defined threshold detailed herein. For example, an indirect relationship can yield a larger defined threshold than a direct relationship.

In some embodiments, as indicated at reference numeral 846, device 800 can annotate OG 810 with attribute 848. Attribute 848 can be indicative of certain information relating to elements such as respective geographical locations of respective organization entities of the organization entities represented by the OG nodes, respective specified languages of the respective organization entities represented by the OG nodes, a history of collaboration or communication between the respective organization entities represented by the OG nodes, and so forth. Thus, attributes 848 can reflect certain additional information relating to organization entities that can be used to improve recommendation data 840.

### Example Methods

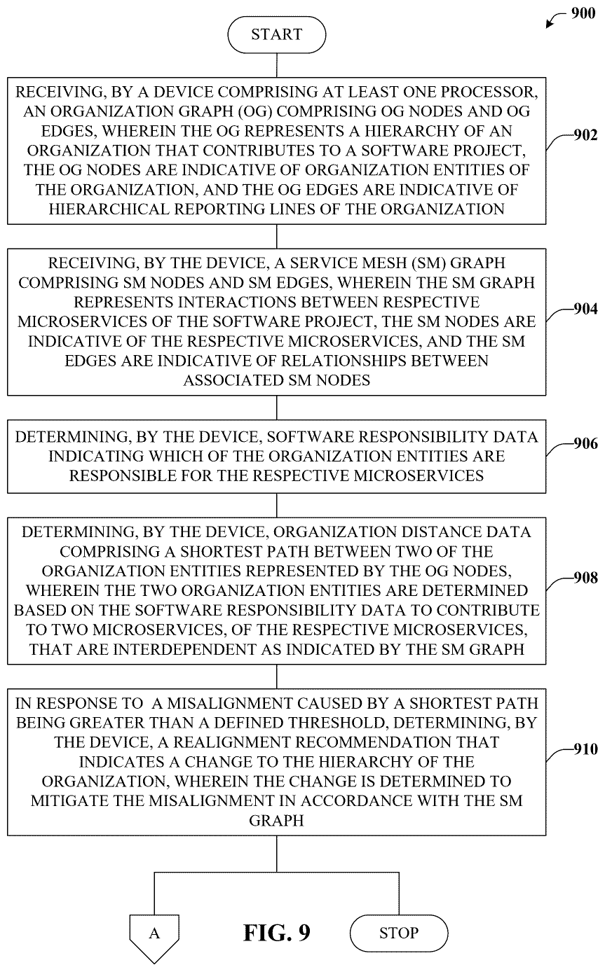

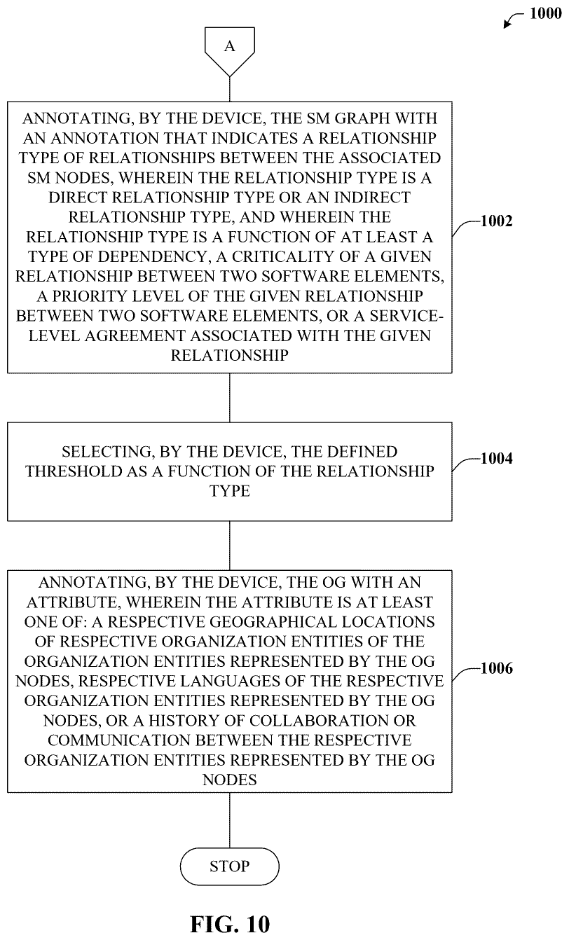

FIGS. 9 and 10 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Turning now to FIG. 9, exemplary method 900 is depicted. Method 900 can generate recommendation data to resolve misalignments between organization structure and microservices architecture in accordance with certain embodiments of this disclosure. While method 900 describes a complete method, in some embodiments, method 900 can include one or more elements of method 1000, reached via insert A, as discussed at FIG. 10.

At reference numeral 902, a device comprising at least one processor can receive an organization graph (OG) comprising OG nodes and OG edges. The OG can represent a hierarchy of an organization that contributes to a software project. The OG nodes can be indicative of organization entities of the organization. The OG edges can be indicative of hierarchical reporting lines of the organization.

At reference numeral 904, the device can receive a service mesh (SM) graph comprising SM nodes and SM edges. The SM graph can represent interactions between respective microservices of the software project. The SM nodes can be indicative of the respective microservices. The SM edges can be indicative of relationships between associated SM nodes.

At reference numeral 906, the device can determine software responsibility data. Software responsibility data can indicate which of the organization entities are responsible for the respective microservices. In some embodiments, such can be readily obtained from a version control system of an associated microservices platform.

At reference numeral 908, the device can determine organization distance data. Organization distance data can comprise a shortest path between any given two of the organization entities represented by the OG nodes. The given two organization entities can be determined, based on the software responsibility data, to contribute to two microservices that are interdependent as indicated by the SM graph.

At reference numeral 910, in response to a misalignment caused by the shortest path being determined to be greater than a defined threshold, the device can determine a realignment recommendation. The realignment recommendation can indicate a change to the hierarchy of the organization. The change can be determined to mitigate the misalignment in accordance with the SM graph. Method 900 can terminate in some embodiments, or proceed to insert A in other embodiments, which is further detailed in connection with FIG. 10.

Turning now to FIG. 10, exemplary method 1000 is depicted. Method 1000 can provide for additional functionality or elements relating to generating recommendation data to resolve misalignments between organization structure and microservices architecture in accordance with certain embodiments of this disclosure.

For example, at reference numeral 1002, the device introduced in FIG. 9 can be configured to annotate the SM graph with an annotation. The annotation can indicate a relationship type for relationships between the associated SM nodes. For example, the relationship type can be a direct relationship type (e.g., a direct dependency) or an indirect relationship type (e.g., an indirect dependency). For instance, the relationship type can be a function of at least a type of dependency, a criticality of a given relationship between two software elements, a priority level of the given relationship between two software elements, a service-level agreement associated with the given relationship, and so on.

A reference numeral 1004, the device can select the defined threshold as a function of the relationship type. In other words, the defined threshold that is used to identify a misalignment can change as a function of whether the relationship type is direct, indirect, or another relationship type.

At reference numeral 1006, the device can annotate the OG with an attribute. The attribute can be at least one of: a respective geographical locations of respective organization entities of the organization entities represented by the OG nodes, respective languages of the respective organization entities represented by the OG nodes, a history of collaboration or communication between the respective organization entities represented by the OG nodes, and so forth.

### Example Operating Environments

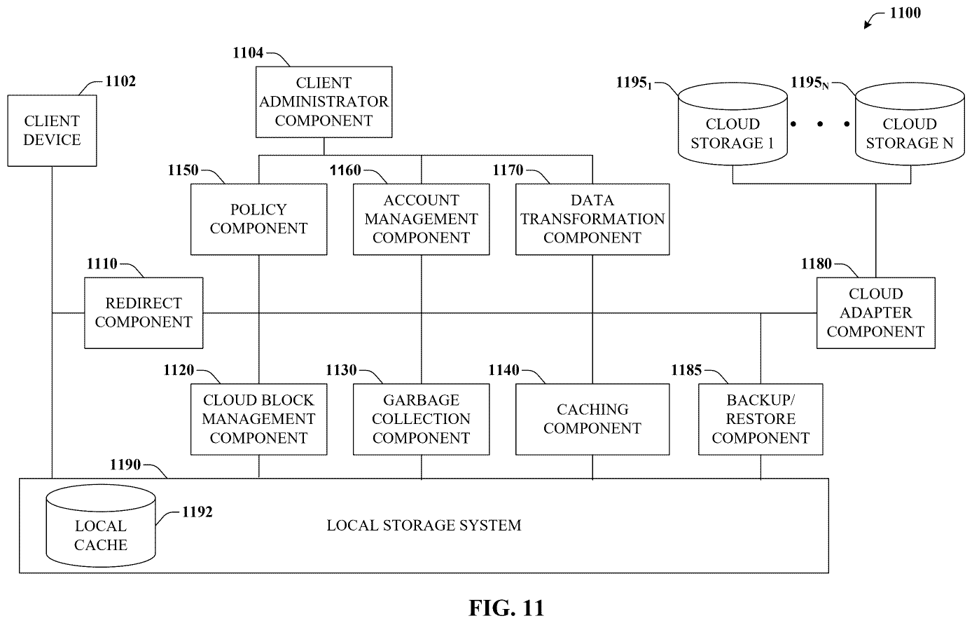

To provide further context for various example embodiments of the subject specification, FIGS. 11 and 12 illustrate, respectively, a block diagram of an example distributed file storage system 1100 that employs tiered cloud storage and block diagram of a computer 1202 operable to execute the disclosed storage architecture in accordance with example embodiments described herein.

Referring now to FIG. 11, there is illustrated an example local storage system including cloud tiering components and a cloud storage location in accordance with implementations of this disclosure. Client device 1102 can access local storage system 1190. Local storage system 1190 can be a node and cluster storage system such as an EMC Isilon Cluster that operates under OneFS operating system. Local storage system 1190 can also store the local cache 1192 for access by other components. It can be appreciated that the systems and methods described herein can run in tandem with other local storage systems as well.

As more fully described below with respect to redirect component 1110, redirect component 1110 can intercept operations directed to stub files. Cloud block management component 1120, garbage collection component 1130, and caching component 1140 may also be in communication with local storage system 1190 directly as depicted in FIG. 11 or through redirect component 1110. A client administrator component 1104 may use an interface to access the policy component 1150 and the account management component 1160 for operations as more fully described below with respect to these components. Data transformation component 1170 can operate to provide encryption and compression to files tiered to cloud storage. Cloud adapter component 1180 can be in communication with cloud storage 1 1195₁ and cloud storage N 1195_{N}, where N is a positive integer. It can be appreciated that multiple cloud storage locations can be used for storage including multiple accounts within a single cloud storage location as more fully described in implementations of this disclosure. Further, a backup/restore component 1185 can be utilized to back up the files stored within the local storage system 1190.

Cloud block management component 1120 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 1120 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 1160 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 1120 based on a list of mappings that the cloud block management component 1120 manages. For example, each stub can be associated with an account, and the cloud block management component 1120 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 1180 manages the sending and receiving of data to and from the cloud service providers. The cloud adapter component 1180 can utilize a set of APIs. For example, each cloud service provider may have provider specific API to interact with the provider.

A policy component 1150 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 1130. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 1130 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 1140 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 1120, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 1140 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 1140 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that the file has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time the stub file is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 1170 can encrypt and/or compress data that is tiered to cloud storage. In relation to encryption, it can be appreciated that when data is stored in off-premises cloud storage and/or public cloud storage, users can request or require data encryption to ensure data is not disclosed to an illegitimate third party. In one implementation, data can be encrypted locally before storing/writing the data to cloud storage.

In one implementation, the backup/restore component 1185 can transfer a copy of the files within the local storage system 1190 to another cluster (e.g., target cluster). Further, the backup/restore component 1185 can manage synchronization between the local storage system 1190 and the other cluster, such that, the other cluster is timely updated with new and/or modified content within the local storage system 1190.

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various example embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can also be connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an example embodiment, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more example embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
at least one processor; and
at least one memory that stores executable instructions that, when executed by the at least one processor, facilitate performance of operations, comprising:
receiving an organization graph (OG) comprising OG nodes and OG edges, wherein the OG represents a hierarchy of an organization that contributes to a software project, the OG nodes are indicative of organization entities of the organization, and the OG edges are indicative of hierarchical reporting lines of the organization;
receiving a service mesh (SM) graph comprising SM nodes and SM edges, wherein the SM graph represents interactions between software elements of the software project, the SM nodes are indicative of the software elements, and the SM edges are indicative of relationships between associated SM nodes;
determine software responsibility data indicating which of the organization entities are responsible for each of the software elements;
determine organization distance data comprising a shortest path between two of the organization entities represented by the OG nodes, wherein the two organization entities are determined, based on the software responsibility data, to contribute to two software elements, of the software elements, that are interdependent as indicated by the SM graph;
in response to the shortest path being determined to be greater than a defined threshold, identifying a misalignment; and
generating recommendation data representative of a realignment recommendation that indicates a change to the hierarchy of the organization, wherein the change is determined to mitigate or eliminate the misalignment in accordance with the SM graph.

2. The device of claim 1, wherein the organization entity represents a role performed by the organization entity and is at least one of an individual entity or a team entity.

3. The device of claim 1, wherein the relationship between the associated SM nodes is at least one of a dependency, an application programming interface (API) call, or a data flow among the associated SM nodes.

4. The device of claim 1, wherein the software responsibility data is determined based on at least one of: a source code repository, version control data, or a project management tool.

5. The device of claim 1, wherein the operations further comprise generating the OG in response to access to at least one of: a human resource data store for the organization, a directory services store, an internal organization store, or a collaboration and communication log store.

6. The device of claim 1, wherein the operations further comprise generating the SM graph in response to access to at least one of: an application configuration store, an application programming interface (API) gateway log store, a service registry store, a monitoring and tracing system store, a configuration and management store, application log or event stream store, or a version control store.

7. The device of claim 1, wherein the operations further comprise annotating the SM graph with an annotation that indicates a relationship type of relationships between the associated SM nodes, wherein the relationship type is a direct relationship type or an indirect relationship type, and wherein the relationship type is a function of at least a type of dependency, a criticality of a given relationship between two software elements, a priority level of the given relationship between two software elements, or a service-level agreement associated with the given relationship.

8. The device of claim 7, wherein the defined threshold is determined or configured as a function of the relationship type.

9. The device of claim 1, wherein the operations further comprise annotating the OG with an attribute, wherein the attribute is at least one of: respective geographical locations of respective organization entities of the organization entities represented by the OG nodes, respective specified languages of the respective organization entities represented by the OG nodes, or a history of collaboration or communication between the respective organization entities represented by the OG nodes.

10. The device of claim 1, wherein the generating of the recommendation data comprises generating the recommendation data in response to combining misalignment metrics across multiple pairs of the organization entities determined to have contributed to interdependent software elements in order to determine a misalignment score.

11. The device of claim 10, wherein the generating of the recommendation data comprises generating the recommendation data in response to identifying multiple restructuring scenarios that reduce the misalignment score.

12. The device of claim 11, wherein the generating of the recommendation data comprises generating the recommendation data in response to ranking the multiple restructuring scenarios according to the misalignment score.

13. A device, comprising:
at least one processor; and
at least one memory that stores executable instructions that, when executed by the at least one processor, facilitate the device to at least:
receive an organization graph (OG) comprising OG nodes and OG edges, wherein the OG represents a hierarchy of an organization that contributes to a software project, the OG nodes are indicative of organization entities of the organization, and the OG edges are indicative of hierarchical reporting lines of the organization;
receive a service mesh (SM) graph comprising SM nodes and SM edges, wherein the SM graph represents interactions between microservices of the software project, the SM nodes are indicative of the microservices, and the SM edges are indicative of relationships between associated SM nodes;
determine software responsibility data indicating respective ones of the organization entities responsible for respective ones of the microservices;
determine organization distance data comprising a shortest path between two of the organization entities represented by the OG nodes, wherein the two organization entities are determined based on the software responsibility data to contribute to two microservices, of the microservices, that are interdependent as indicated by the SM graph;
in response to the shortest path being greater than a defined threshold, identify a misalignment; and
determine realignment recommendation data representing a realignment recommendation that indicates a change to the hierarchy of the organization, wherein the change is determined to mitigate the misalignment in accordance with the SM graph.

14. The device of claim 13, wherein the realignment recommendation data is determined in response to combining misalignment metrics across multiple pairs of the organization entities that contributed to interdependent software elements in order to determine a misalignment score.

15. The device of claim 14, wherein the realignment recommendation data is determined in response to identifying multiple restructuring scenarios that reduce the misalignment score.

16. The device of claim 15, wherein the realignment recommendation data is determined in response to ranking the multiple restructuring scenarios according to the misalignment score.

17. A method, comprising:
receiving, by a device comprising at least one processor, an organization graph (OG) comprising OG nodes and OG edges, wherein the OG represents a hierarchy of an organization that contributes to a software project, the OG nodes are indicative of organization entities of the organization, and the OG edges are indicative of hierarchical reporting lines of the organization;
receiving, by the device, a service mesh (SM) graph comprising SM nodes and SM edges, wherein the SM graph represents interactions between respective microservices of the software project, the SM nodes are indicative of the respective microservices, and the SM edges are indicative of relationships between associated SM nodes;
determining, by the device, software responsibility data indicating which of the organization entities are responsible for the respective microservices;
determining, by the device, organization distance data comprising a shortest path between two of the organization entities represented by the OG nodes, wherein the two organization entities are determined based on the software responsibility data to contribute to two microservices, of the respective microservices, that are interdependent as indicated by the SM graph;
in response to the shortest path being determined to be greater than a defined threshold, identifying a misalignment; and
determining, by the device, a realignment recommendation that indicates a change to the hierarchy of the organization, wherein the change is determined to mitigate the misalignment in accordance with the SM graph.

18. The method of claim 17, further comprising, annotating, by the device, the SM graph with an annotation that indicates a relationship type of relationships between the associated SM nodes, wherein the relationship type is a direct relationship type or an indirect relationship type, and wherein the relationship type is a function of at least a type of dependency, a criticality of a given relationship between two software elements, a priority level of the given relationship between two software elements, or a service-level agreement associated with the given relationship.

19. The method of claim 18, further comprising selecting, by the device, the defined threshold as a function of the relationship type.

20. The method of claim 17, further comprising annotating, by the device, the OG with an attribute, wherein the attribute is at least one of: a respective geographical locations of respective organization entities of the organization entities represented by the OG nodes, respective languages of the respective organization entities represented by the OG nodes, or a history of collaboration or communication between the respective organization entities represented by the OG nodes.
